(19) United States
(12) Patent Application Publication
(10) Pub. No.: US 2011/0041919 A1
(43) Pub. Date: Feb. 24, 2011

(54) System of identification fittings for hydraulic pressure lines

(76) Inventor: Mark E. Turner, Kalamazoo, MI (US)

Correspondence Address: FLYNN THIEL BOUTELL & TANIS, P.C., 2026 RAMBLING ROAD, KALAMAZOO, MI, 49008-1631, US

(21) Appl. No.: 12/583,473

(22) Filed: Aug. 21, 2009

(51) Int. Cl. F16K 37/00

(52) U.S. Cl. 137/1; 137/552

(57) ABSTRACT

An identification system comprises removable fittings for the pressure lines or hoses. The identification system in particular comprises sets of matched identification fittings which are joinable together, but separable for individual mounting to respective ones of a pressure line fitting and the port to which the pressure fitting is connected. The identification fittings have matched surface indicia, which has a unique identifier that is common to both of the matched identification fittings provided as a set. For example, one set of identification fittings may each be marked with a visible indicator such as a common letter such as a capital A.

### FIELD OF THE INVENTION

The invention relates to an identification system of fittings for hydraulic or pneumatic pressure lines such as used on hydraulically or pneumatically powered equipment.

### BACKGROUND OF THE INVENTION

Numerous types of equipment include hydraulic or pneumatically driven actuators which are supplied with a pressurized fluid from a pressure source, which source may include a control valve for supplying the pressurized fluid to drive the actuator which is subjected to loads. For example, scissor lifts, tractors and other such equipment typically have a pressurized actuator which operates a driven component that is subjected to a system load. The actuator may be a telescoping pneumatic or hydraulically driven cylinder which displaces the driven component, wherein the driven component may be the bed of a scissor lift, or the bucket arm of a tractor. Such equipment may use any type of actuator such as a hydraulic motor, and any other type of driven component subjected to a load such as pumps and the like.

Such equipment thereby comprises a variety of system components including the afore-mentioned actuators and pressure source, which are interconnected by high pressure lines, such as hoses and pipes that receive pressurized fluid from an upstream component and direct the fluid to a downstream component.

It is an object of the invention to provide an improved apparatus and method for facilitating the removal and then re-installation of the pressure hoses and pressure lines.

The invention relates to an identification system comprising removable fittings for the pressure lines or hoses. The identification system comprises sets of matched identification fittings which are joinable together in pairs when not in use, but separable for individual mounting to respective ones of a pressure line connector and the port to which the pressure line connector is connected. The identification fittings have matched surface indicia each of which has a unique identifier that is common to both of the matched identification fittings provided as a set. For example, one set of identification fittings may each be marked with a visible indicator such as a common letter such as a capital A.

Multiple sets of the identification fittings are provided, the sets being provided with different surface indicia or visible indicators so that multiple sets may be used to mark multiple line connectors with the different indicators such as a variety of letters A, B, C and D, or alpha-numeric identifiers such as 1 and 1A, 2 and 2A, etc. In this regard, the corresponding identifiers 1 and 1A may be used at opposite ends of a single pressure line to indicate that the two separate equipment ports are connected to the opposite ends of a single pressure line, which pressure line is indicated with the identification fitting number 1 on one end, and the identification fitting number 1A at the opposite end.

Preferably, the identification fittings are formed as closed caps so as to serve as a closure on each of the equipment port and the line connector. Since many of the pressure lines may be provided with hydraulic fluid, formation of the identification fittings as closures or caps will prevent the leakage of the pressure fluid from the pressure line when uninstalled, and also prevents leakage of the pressure fluid from the upstream and downstream components.

After re-installation of the pressure line, the removed identification fittings may then be rejoined together so that any residual hydraulic pressure fluid is retained within the interiors of the mated identification fittings so that the mated set may then be stored such as in a toolbox without leaking or contaminating the other tools and articles stored therein.

With the foregoing invention, an improved structure and method are provided for use in removing and re-installing pressurized lines such as from hydraulic and pneumatic equipment.

Other objects and purposes of the invention, and variations thereof, will be apparent upon reading the following specification and inspecting the accompanying drawings.

### BRIEF DESCRIPTION OF DRAWINGS

FIG. 1 is a diagrammatic view of a pressurized system of equipment illustrating a pressurized actuator as one system component and a pressure source as an upstream system component wherein the system components are interconnected by hydraulic or pneumatic pressure lines.

FIG. 2 is a side view of a set of mated identification fittings in a first configuration.

FIG. 3 illustrates a primary identification fitting of the first set of FIG. 2 being mated to a pressure line or an equipment port.

FIG. 4 is an end view thereof.

FIG. 5 illustrates a secondary identification connector of the first set of FIG. 2 connected to the other one of a pressure line or equipment port.

FIG. 6 is an end view thereof.

FIG. 7 illustrates a primary identification fitting in a third configuration.

FIG. 8 is an end view thereof.

FIG. 9 illustrates a secondary identification fitting in the second configuration.

FIG. 10 is an end view thereof.

FIG. 11 illustrates a primary identification connector in a third configuration.

FIG. 12 is an end view thereof.

FIG. 13 illustrates a secondary identification connector in the third configuration.

FIG. 14 is an end view thereof.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

Referring to FIG. 1, the invention is usable with any of a variety of pressure systems or equipment 10 which may include hydraulic or pneumatically driven actuators 11 which are supplied with a pressurized fluid from a pressure source 12, which source 12 may include a control valve 14 for supplying the pressurized fluid to drive the actuator 11 which is subjected loads. For example, scissor lifts, tractors and other such equipment typically have a pressurized actuator such as 11 which operates a driven component 15 that is subjected to a system load and diagrammatically shown in FIG. 1. The actuator 11 may be a telescoping pneumatic or hydraulically driven cylinder 16 which displaces the driven component 15, wherein the driven component 15 may be the bed of a scissor lift, or the bucket arm of a tractor. Such equipment 10 may alternatively use any type of actuator such as a hydraulic motor, and any other type of driven component subjected to a load such as pumps and the like.

Such equipment 10 thereby comprises a variety of system components including the afore-mentioned actuator 11 and pressure source 12, which are interconnected by pressurized supply lines 20 and 21, such as hoses and pipes that receive pressurized fluid from an upstream component 22 and direct the fluid to a downstream component 23. Typically, a downstream system component 23 is provided with a pressure fluid inlet port 24 for receiving the pressurized fluid from line 20, for example, to effect driving operation of the equipment when the downstream system component 23 is an actuator 11. The system component 23 also typically includes a discharge port 25 for the return flow of the pressurized fluid through line 21 back to an upstream system component 22 such as the pressure source 12.

The upstream component 22 in turn also includes an outlet port 26 which feeds the downstream inlet port 24 by line 20, as well as an inlet port 27 for receiving the return fluid from the downstream component 23 by line 21. The upstream components also may comprise a fluid pump (not shown) for pressurizing the hydraulic or pneumatic fluid, and may also include control equipment such as the control valve 12 for selectively supplying and controlling the flow of pressurized fluid to the equipment load or downstream system component 23. Since the fluid source and equipment load typically are located remote or separate from each other, such equipment uses the conventional pressure lines such as lines 20 and 21 which have first and second connectors 30/31 and 32/33 on the opposite end thereof for selective connection to the various inlet ports 29/24 and outlet ports 30/25 of the system components. These fluid line connectors 30/31 and 32/33 may have a variety of configurations, and in one configuration may either be one of a male threaded connector 35 (FIG. 5) or a female threaded connector 36 (FIG. 4) which cooperates with the other of a male or female fitting 36, 35 provided on the various ports of the system components. Alternatively, the connectors could be configured as quick-connect couplers.

These flexible pressure lines 20/21 or more particularly, pressurized fluid hoses have the end connectors 30-33 on the opposite end thereof. During repair or servicing of the equipment 10, it may be necessary to remove the hoses 20, 21 by disconnecting the first and second end connectors 30-33 from their respective ports 24-27 to which such connectors 30-33 are mated. If multiple hoses 20, 21 are removed, it can be difficult to properly reconnect and match up a port 24-27 on one of-the upstream and downstream system components with the respective port on the other of the upstream and downstream system components since it may not be readily apparent what parts of two different system components are interrelated once the pressure line is removed.

The invention provides an improved apparatus and method for facilitating the removal and then re-installation of the pressure hoses and pressure lines 20 and 21.

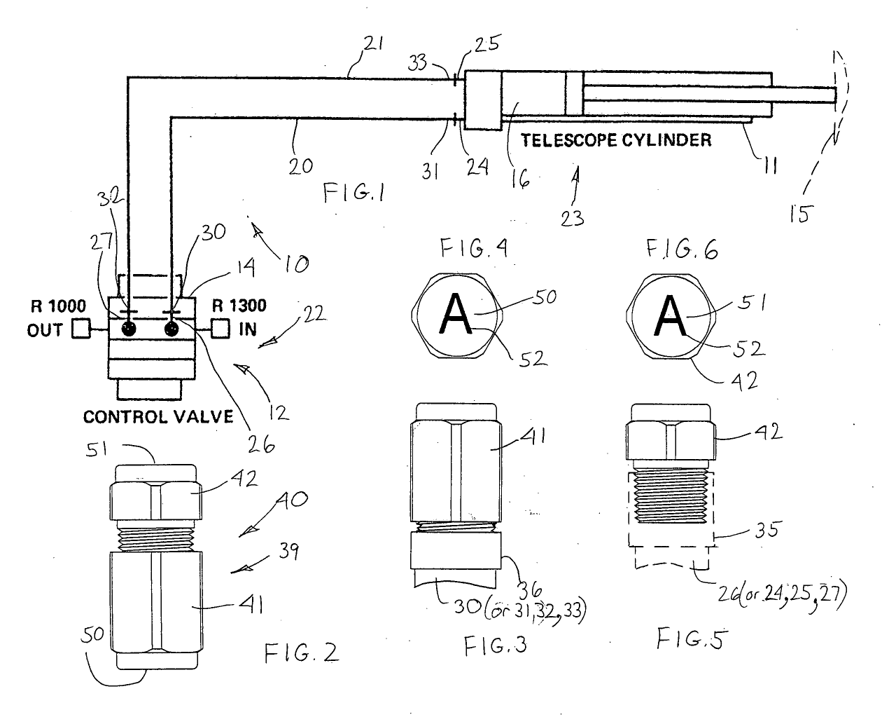

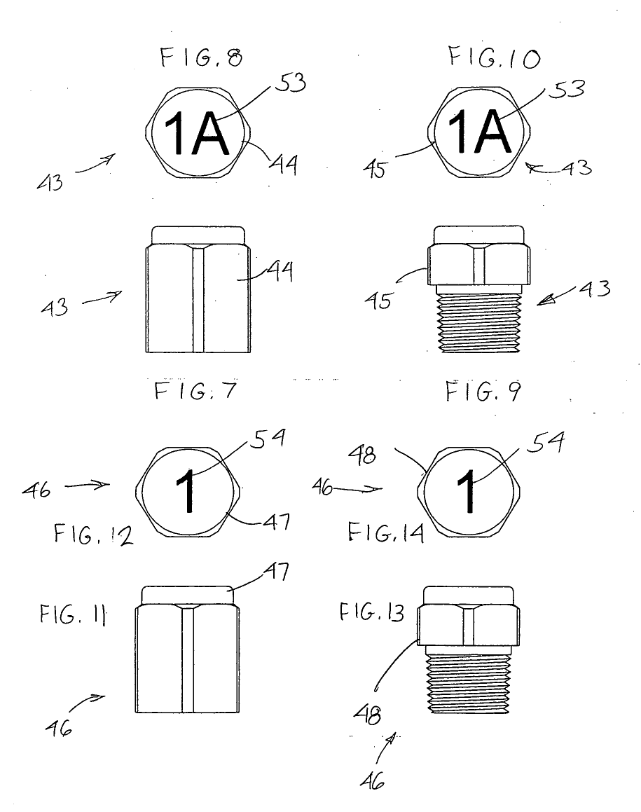

Referring to FIGS. 2-6, the invention therefore relates to an identification system 39 comprising at least one set 40 of removable fittings 41 and 42 for the pressure lines or hoses 20 and 21. The identification system 39 in particular comprises multiple sets 40, 43, 46 of matched identification fittings 41/42 (FIG. 2), 44/45 (FIGS. 7-10), and 47/48 (FIGS. 11-14). Referring to the first set 40, the fittings 41/42 are joinable together, but are separable for individual mounting to respective ones of a pressure line connector 30, 31, 32 or 33 and the port 24, 25 26 or 27 to which the line connector 30-33 is connected.

Referring to set 40 of FIGS. 2-6, the identification fittings 41 and 42 have matched surface indicia 50, 51 which comprise a unique identifier that is common to both of the matched identification fittings 41, 42 provided as a set 40. For example, the one set 40 of identification fittings 41, 42 may each be marked with a visible indicator 52 which is a common letter such as a capital A. In a conventional joining of a pressure connector 30-33 to a respective equipment port 24-27, a connector 30 and port 24 have matable configurations typically defined by a male configuration 36 and a female configuration 35 which are matable together. When the line connector 30 and equipment port 24 are coupled together in use, a sealed connection is defined therebetween which allows for the flow of the hydraulic or pneumatic pressure fluid therethrough. However, during such instances as repair of the equipment, it may be necessary to remove one or both ends of a pressure line 20, 21 from the respective equipment port to which the pressure line is connected. It can be difficult, however, upon removal of such lines or hoses 20, 21 to be able to monitor and track the two different equipment ports 24/26 or 25/27 to which the opposite ends of each pressure line 20 or 21 should be connected, particularly when the multiple pressure lines 20 and 21 are all removed.

To allow for continuous tracking of the proper equipment ports 24-27 and provide for reinstallation of the pressure lines 20 and 21 in the appropriate locations, one or more sets 40, 43, 46 of identification fittings are provided wherein the pressure fittings 41/42 have a connector configuration which essentially matches the connector configurations used in the line connector 30 and equipment port 26. In this regard, the connector 30 and equipment port 36 may have threaded, male and female connectors 36/35 wherein the set 40 of identification fittings 41/42 would also have corresponding male and female threaded connectors. Upon removal of any connector 30-33 from the respective equipment port 24-27, the two identification fittings 41 and 42 would be separated from each other (FIG. 2) where one of such identification fittings 41 would be coupled to the line connector 30 while the other identification fitting 42 would be connected to the equipment port 26. Hence, both the connector 30 and the port 26 are now marked with the common visible indicator 52 that is provided on the set 40 of identification fittings 41/42 so that the connector 30, such as when marked with the capital letter A, may be readily re-installed to the equipment port 24 which is similarly marked with the matched identifier 52, namely the capital letter A.

Multiple sets 40, 43, 46 of the identification fittings 41/42, 44/45, 47/48 are provided, each set being provided with different surface indicia or visible indicators 52, 53, 54 so that multiple sets may be used to mark multiple pressure fittings 24-27 with the different indicators such as a variety of letters A, B, C and D (like FIGS. 4 and 6), or alpha-numeric identifiers such as 1 and 1A, 2 and 2A, etc (like FIGS. 8, 10, 12, 14). In this regard, the corresponding identifiers 1 and 1A are related to each other by the use of a common numeral as the first or primary character and may be used at opposite ends of a single pressure line 20 to indicate that the two separate equipment ports 24/26 are connected to the opposite ends of a single pressure line 20. In this regard, the pressure line 20 is indicated with the identification fitting number 1 on one end, and the identification fitting number 1A at the opposite end. In addition to alpha-numeric characters being used, other visible indicators may be uniquely provided such as different colors or combinations of colors such as being provided in striped patterns. Preferably then, a kit may be provided which comprises multiple sets 40, etc. of fittings 41, 42, etc. wherein each set has a different indicator 52, etc. thereon. In one example, a kit may comprise eight (8) fitting sets numbered sequentially such as by 1-8, or 1, 1A, 2, 2A, 3, 3A, 4, 4A. Since an actuator 11 typically has two pressure lines 20, 21 associated therewith, eight sets, i.e. four pairs of fitting sets, would permit disconnection of four actuators 11.

Preferably, the identification fittings 41/42, 44/45 and 47/48 are formed as closed, cylindrical caps so as to serve as a closure on each of the equipment port 24-27 and the pressure fitting 30-33 when disconnected. Since many of the pressure lines 20, 21 may be provided with hydraulic fluid or need to be protected against outside contaminants, formation of the identification fittings as closures or caps will prevent the leakage of the pressure fluid from the pressure line, and also prevents leakage of the pressure fluid from the equipment load and equipment pressure source. Further, by forming the identification fittings as closures or caps, joining of a pair of identification fittings, such as by the male and female threaded connectors thereof, also allows for the interior portions or chambers of each set of identification fittings to be completely enclosed so as to retain any dirt or pressure fluid which may have come into contact with and which remains on the interior surfaces of the identification fittings. For example, use of the identification fittings on a pressure line and equipment port may result in the interiors of the identification fittings retaining some of the hydraulic pressure fluid thereon. After re-installation of the pressure line 20, 21, the removed identification fittings 41, 42, etc. may then be rejoined together so that all of the hydraulic pressure fluid is retained within the interiors of the mated identification fittings 41 and 42 (FIG. 2) so that the mated set 40 may then be stored such as in a toolbox without causing leakage or contamination of the other tools and articles stored therein.

It is further noted that servicing may involve replacing a line 20 or any other line with a new line 20 such as when the pressure line has naturally deteriorated or is damaged. Hence, the fittings attached to original line 20 may then be removed and attached to the ends of new replacement line wherein after this servicing, the new line is then installed on the system components in place of the worn-out line.

With the foregoing invention, an improved structure and method are provided for use in removing and re-installing pressure lines from hydraulic and pneumatic equipment.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. An identification system for pressure lines carrying pressurized fluids between system components and having end connectors at opposite ends thereof which are connectable to component ports, the system comprising:
one or more sets of matched identification fittings which are joinable together when not in use, but are separable for individual mounting to respective ones of a pressure line end connector and a component port to which the end connector is connected, said identification fittings have matched surface indicia which comprise a unique identifier on each said identification fitting that is common to both of the matched identification fittings provided as said set.

2. The identification system according to claim 1, wherein, one said set has each of said matched identification fittings marked has said identifier defined by at least one of a group of alpha-numeric characters.

3. The identification system according to claim 2, wherein said identifier comprises a letter.

3. The identification system according to claim 2, wherein said identifier comprises a number.

4. The identification system according to claim 3, wherein said identifier comprises a letter in combination with said number.

5. The identification system according to claim 1, wherein multiple said sets of the matched identification fittings are provided, said sets being provided with different said identifiers so that said multiple sets may be used to mark multiple end connectors with the different identifiers.

6. The identification system according to claim 5, wherein said identifiers on two said sets are related and comprise either a common letter or number as a first character on both said sets and at least a second character which is provided on one of said sets which distinguishes said two sets from each other, said related sets being usable on opposite ends of one pressure line.

7. The identification system according to claim 6, wherein said first character comprises a number, and said second character is a letter.

8. The identification system according to claim 1, wherein said identification fittings are formed as closed caps which serve as a closure on each of a equipment port and an end connector to which said identification fittings connect to prevent leakage of the pressure fluid from the pressure line when uninstalled, and also prevent leakage of the pressure fluid from the ports of system components.

9. The identification system according to claim 8, wherein said matched identification fittings of each said set have matable male and female connector configurations which allow mating of each said identification fitting with the other matched identification fitting when not in use.

10. The identification system according to claim 8, wherein said sets of matched identification fittings are provided as a kit of a plurality of said sets wherein each said set has said identifier thereon which is common between both of said matched identification fittings of said set but different from each said identifier of all of the other sets of said kit.

11. A method of servicing pressure lines and system components of pressurized equipment wherein said pressure lines carry pressurized fluids between said system components and have end connectors at opposite ends thereof which removably couple to component ports on said system components, the method comprising the steps of:
providing a kit comprising a plurality of sets of matched identification fittings which are joinable together when not in use, but are separable for individual mounting to respective ones of said pressure line end connector and said component port to which the end connector is connected, said identification fittings have matched surface indicia which comprise a unique identifier on each said identification fitting that is common to both of the matched identification fittings provided as said set, each said set of said matched identification fittings having said identifier thereon which is common between both of said matched identification fittings of said set but different from each said identifier of all of the other sets of said kit;
removing a first said end connector of a primary said pressure line from a first said port coupled thereto, and then connecting one of said matched equipment fittings of a first said set to said first end connector and the other of said matched equipment fittings to said first port such that said first end connector and said first port are marked with said common identifier of said matched identification fittings of said first set; and
removing a second said end connector of said primary said pressure line from a second said port coupled thereto, and then connecting one of said matched equipment fittings of a second said set to said second end connector and the other of said matched equipment fittings to said second port such that said second end connector and said second port are marked with said common identifier of said matched identification fittings of said second set.

12. The method according to claim 11, further comprising the steps of:
completing servicing on said equipment:
removing said matched equipment fittings of said first set from said first end connector and said first port after servicing;
reattaching said first end connector to said first port;
removing said matched equipment fittings of said second set from said second end connector and said second port after servicing;
reattaching said second end connector to said second port.

13. The method according to claim 12, wherein:
said first and second sets of the matched identification fittings are provided with different said identifiers so that said first and second sets are used to mark said first and second end connectors and said first and second ports with the different indicators.

14. The method according to claim 13, wherein said identifiers on two said sets are related and comprise either a common letter or number as a first character on both said sets and at least a second character which is provided on one of said sets which distinguishes said two sets from each other, said method including the step of using one of said related sets on one end of said first pressure line and the other of said related sets on the other end of said first pressure line.

15. The method according to claim 14, wherein said identification fittings are formed as closed caps which serve as a closure on each of said equipment ports and said end connectors to which said identification fittings connect to prevent leakage of the pressure fluid from the pressure line when uninstalled, and also prevent leakage of the pressure fluid from the ports of system components.

16. The method according to claim 12, wherein said matched identification fittings of each said set have matable male and female connector configurations which allow mating of each said identification fitting with the other matched identification fitting when not in use, said method including the step of mating said matched identification fittings together with each other after said removing steps.
